(19) United States
(12) Patent Application Publication
(10) Pub. No.: US 2016/0172640 A1
(43) Pub. Date: Jun. 16, 2016

(54) LOCK MECHANISM

(71) Applicant: Panasonic Intellectual Property Management Co., Ltd., Osaka (JP)

(72) Inventor: KENJI KADOWAKI, Osaka (JP)

(21) Appl. No.: 14/932,960

(22) Filed: Nov. 4, 2015

(30) Foreign Application Priority Data
Dec. 15, 2014 (JP) 2014-252617
Oct. 28, 2015 (JP) 2015-211961

(51) Int. Cl. H01M 2/10

(52) U.S. Cl. CPC H01M 2/1022; H01M 2220/30

(57) ABSTRACT

The lock mechanism of the present disclosure has a housing, a lid, a lock section, and a buffer member. The housing has a storage section, and a first groove and an opening that are disposed outside the storage section. The lid is removable from the device or disposed on it so as to be openable/closable, and covers the storage section. The lock section has a first protrusion to be fitted with the lid on one end and a second protrusion to be inserted in the opening on the other end. The buffer member, which is elastically deformable, is disposed in the first groove, and abuts the housing, the lid, and the second protrusion of the lock section. The lock section rotates on a rotation shaft disposed between the first protrusion and the second protrusion.

### BACKGROUND

1. Technical Field

The present disclosure relates to a lock mechanism for retaining components arranged in its housing so as not to be dropped out of the housing.

2. Description of the Related Art

If a mobile device, such as a mobile phone, has a shock or a vibration caused by an accidental fall, the battery cover can come off the housing due to an impact on the housing. To protect the battery cover from come-off, some suggestions on lock mechanism have been made.

For example, Patent Literature 1 suggests a mechanism in which a lock member is retained at a lock position by a lock spring member, so that the battery cover is protected from come-off.

### CITATION LIST

### Patent Literature

PTL 1: Japanese Unexamined Patent Application Publication No. 2003-217536

### SUMMARY

The purpose of the present disclosure is to provide a lock mechanism that protects the battery cover from come-off due to impact caused by an accidental fall of the device; on the other hand, that allows the battery cover to be easily removed from the housing as needed.

The lock mechanism of the present disclosure has a housing, a lid, a lock section, and a buffer member. The housing has a storage section, and a first groove and an opening that are disposed outside the storage section. The lid is removable from the device or disposed on it so as to be openable/closable, and covers the storage section. The lock section has a first protrusion to be fitted with the lid on one end and a second protrusion to be inserted in the opening on the other end. The buffer member, which is elastically deformable, is disposed in the first groove, and abuts the housing, the lid, and the second protrusion of the lock section. The lock section rotates on a rotation shaft disposed between the first protrusion and the second protrusion.

The present disclosure provides a lock mechanism that protects the battery cover from come-off due to impact caused by an accidental fall of the device; on the other hand, that allows the user to easily remove the battery cover from the housing as needed.

### BRIEF DESCRIPTION OF DRAWINGS

FIG. 1 is a perspective view showing an appearance, seen from the front side, of an electronic device in accordance with a first exemplary embodiment;

FIG. 2 is a perspective view showing an appearance, seen from the back side, of the electronic device in accordance with the first exemplary embodiment;

FIG. 3 is an exploded perspective view, seen from the back side, of the electronic device in accordance with the first exemplary embodiment;

FIG. 4 is a schematic view of a configuration example of the lock mechanism, showing a cross section taken along the line A-A of FIG. 2;

FIG. 5 illustrates a locked state of the lock mechanism in accordance with the first exemplary embodiment;

FIG. 6 illustrates a state having a slight rotation of the lock mechanism in accordance with the first exemplary embodiment;

FIG. 7 illustrates a lock-release operation of the lock mechanism in accordance with the first exemplary embodiment;

FIG. 8 illustrates a lock-released state of the lock mechanism in accordance with the first exemplary embodiment;

FIG. 9 illustrates a state, where the lid has been removed, of the lock mechanism in accordance with the first exemplary embodiment;

FIG. 10 shows an example (modification A) of the buffer member;

FIG. 11 shows an example (modification B) of the buffer member; and

FIG. 12 shows an example (modification C) of the buffer member.

### DETAILED DESCRIPTION OF THE PREFERRED EMBODIMENTS

Hereinafter, exemplary embodiments will be described in detail, with reference to the accompanying drawings. However, details beyond necessity (for example, descriptions on well-known matters or on substantially identical structures) may be omitted to eliminate redundancy from the description below for easy understanding of those skilled in the art.

It is to be understood that the accompanying drawings and the description below are for purposes of full understanding of those skilled in the art and are not to be construed as limitation on the scope of the claimed disclosure.

### Exemplary Embodiment 1

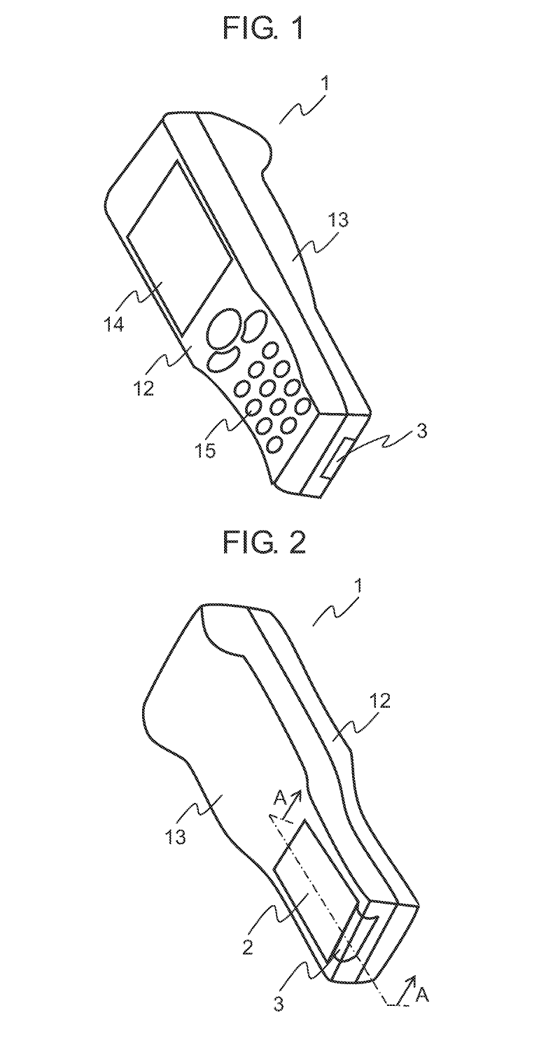

Hereinafter, the structure of the first exemplary embodiment of the present disclosure will be described with reference to FIGS. 1 through 9. An electronic device having the lock mechanism of the present disclosure will be described as an example.

### [1. Structure]

[1-1. Structure of Electronic Device]

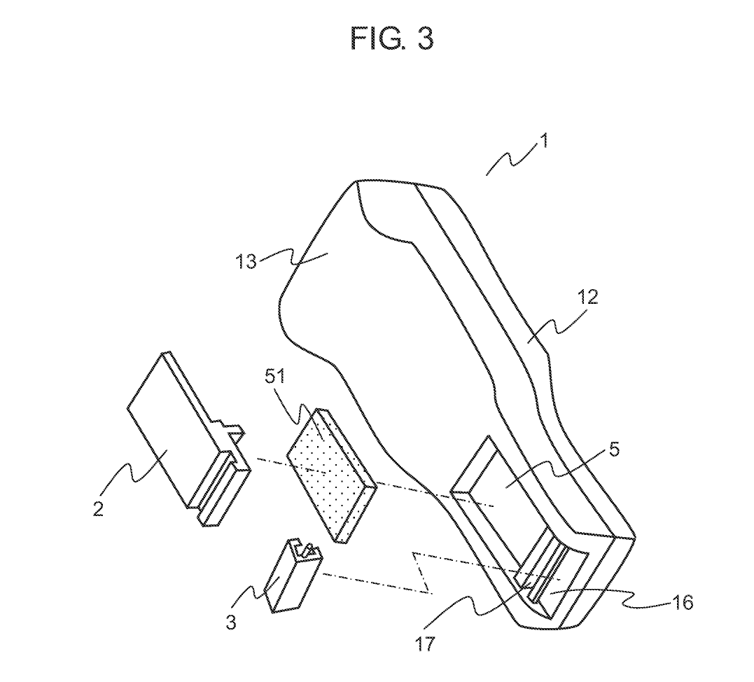

FIG. 1 is a perspective view showing an appearance, seen from the front side, of an electronic device. FIG. 2 is a perspective view showing an appearance, seen from the back side, of the electronic device. FIG. 3 is an exploded perspective view, seen from the back side, of the electronic device.

As shown in FIGS. 1 through 3, the outer case of electronic device 1 is formed of front cover 12, back cover 13, and lid 2. The outer case accommodates display 14, battery 51, and a circuit board (not shown) therein. Front cover 12 and back cover 13 are an example of a housing.

Electronic device 1 has display 14 in the upper section on the front side. Operating section 15 is disposed under display 14. Electronic device 1 further has storage section 5 and lid 2. Storage section 5, which accommodates battery 51, is disposed in the lower section on the back side of electronic device 1. Lid 2, which is a removable or openable/closable structure, covers storage section 5 so as to retain battery 51 in storage section 5. Storage section 5 accommodates battery 51 so as to be removable. Further, electronic device 1 has lock section 3 for engaging lid 2 with back cover 13 (i.e., for locking lid 2 to back cover 13). Back cover 13 has first groove 17 and opening 16 on the outer side of storage section 5. Battery 51 is an example to be contained in storage section 5.

[1-2. Structure of Lock Mechanism]

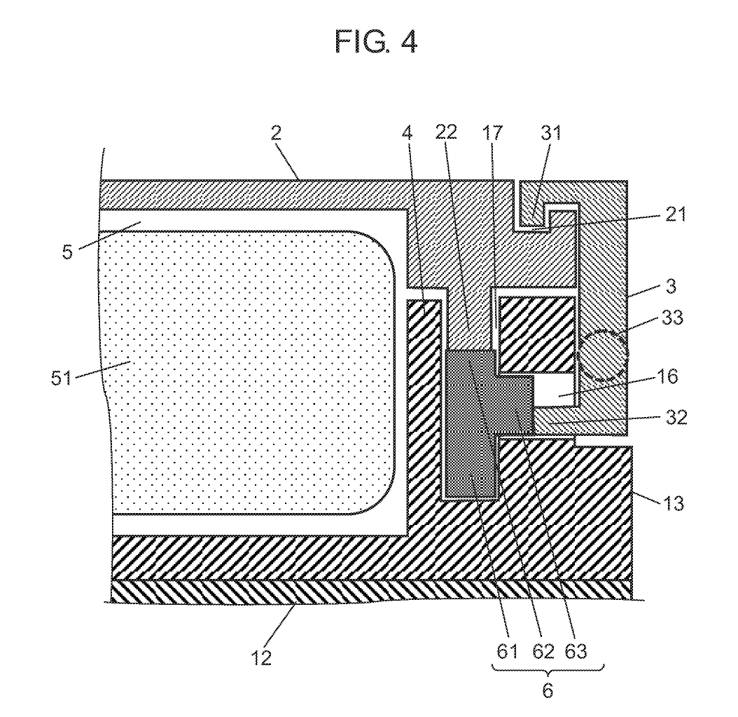

FIG. 4 is a schematic view of a configuration example of the lock mechanism, showing a cross section taken along the line A-A of FIG. 2. Specifically, FIG. 4 shows a locked state where battery 51 is accommodated in storage section 5 and lid 2 is engaged with back cover 13 by lock section 3. As shown in FIG. 4, the lock mechanism of the first exemplary embodiment is formed of back cover 13, lid 2, lock section 3, and buffer member 6.

First groove 17 of back cover 13, as shown in FIG. 4, is formed on the outer side of storage section 5 via wall section 4, and it opens toward the back side (i.e., on the side of lid 2). Opening 16 of back cover 13 is formed on the outer side of first groove 17 and it opens toward the lower side (i.e., on the side of lock section 3) of electronic device 1. First groove 17 communicates with opening 16 in back cover 13. First groove 17 is formed on the both sides of opening 16, that is, on the front side (on the side of front cover 12) and on the back side (on the side of lid 2).

Lid 2 has second groove 21 that engages with lock section 3 and first abutment section 22 that protrudes toward buffer member 6 and abuts on it.

Lock section 3 has a substantially U-shape and covers opening 16 of back cover 13 therein. One end of lock section 3 is first protrusion 31 that engages with second groove 21 of lid 2, and the other end of lock section 3 is second protrusion 32 that is inserted in opening 16 of back cover 13. Further, between first protrusion 31 and second protrusion 32, lock section 3 has rotation shaft 33 whose both ends are fitted in each recess of back cover 13. First protrusion 31 extends toward lid 2 and then protrudes in the direction of back cover 13. Second protrusion 32 protrudes toward storage section 5.

Buffer member 6 is disposed in first groove 17 of back cover 13; to be specific, buffer member 6 abuts against abutment section 22 of lid 2 and second protrusion 32 of lock section 3, by which buffer member 6 has a compressive deformation under the pushing force of abutment section 22 and second protrusion 32. Buffer member 6, which has a T-shape cross section as shown in FIG. 4, has three insert sections (of first insert section 61, second insert section 62, and third insert section 63). First insert section 61 is inserted in first groove 17 on the side of front cover 12 and abuts back cover 13. Second insert section 62, which is opposite to first insert section 61, is inserted in first groove 17 on the side of lid 2 and abuts against abutment section 22 of lid 2 in first groove 17. Third insert section 63 is inserted in opening 16 and abuts against second protrusion 32 of lock section 3 in opening 16. Preferably, buffer member 6 should be elastically deformable; specifically, it should be a rate-dependent material whose reaction force changes with deformation rate. For example, buffer member 6 may be a resin of silicon series and rubber material.

### [2. Workings]

[2-1. Locked State]

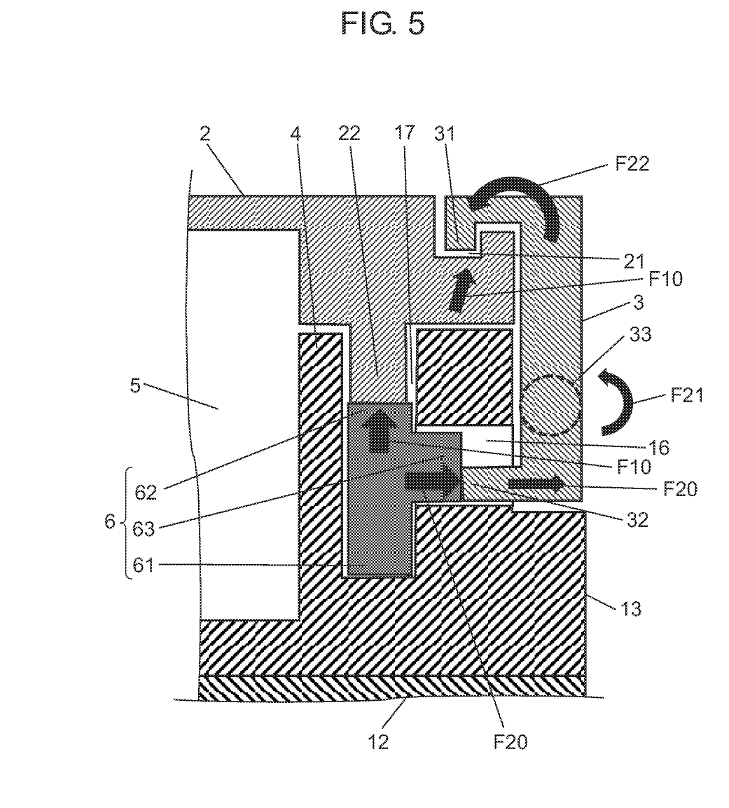

FIG. 5 illustrates the locked state of the lock mechanism. FIG. 5 is an enlarged view of the lock mechanism of FIG. 4. Buffer member 6 has a compressive deformation under the pushing force of abutment section 22 of lid 2 and second protrusion 32 of lock section 3. Under the state, buffer member 6 generates reaction force against lid 2 (shown by arrow F10) and reaction force against lock section 3 (shown by arrow F20). At that time, the reaction force generated in buffer member 6 (shown by arrow F10) pushes lid 2 upward, by which first protrusion 31 of lock section 3 engages in second groove 21 of lid 2. The engagement suppresses the movement of lock section 3 in the direction of engagement release (i.e., clockwise in FIG. 5). At the same time, the reaction force generated in buffer member 6 (shown by arrow F20) pushes back second protrusion 32 of lock section 3 rightward, which rotates rotation shaft 33 of lock section 3 in the direction of arrow F21. That is, first protrusion 31 has a rotative movement (along arrow F22) toward second groove 21. In this way, first protrusion 31 of lock section 3 has a rotative movement in the lock direction (i.e., counterclockwise in FIG. 5). As a result, the locked state (i.e., engagement between second groove 21 of lid 2 and first protrusion 31 of lock section 3) is maintained.

[2-2. State of Device Upon Impact]

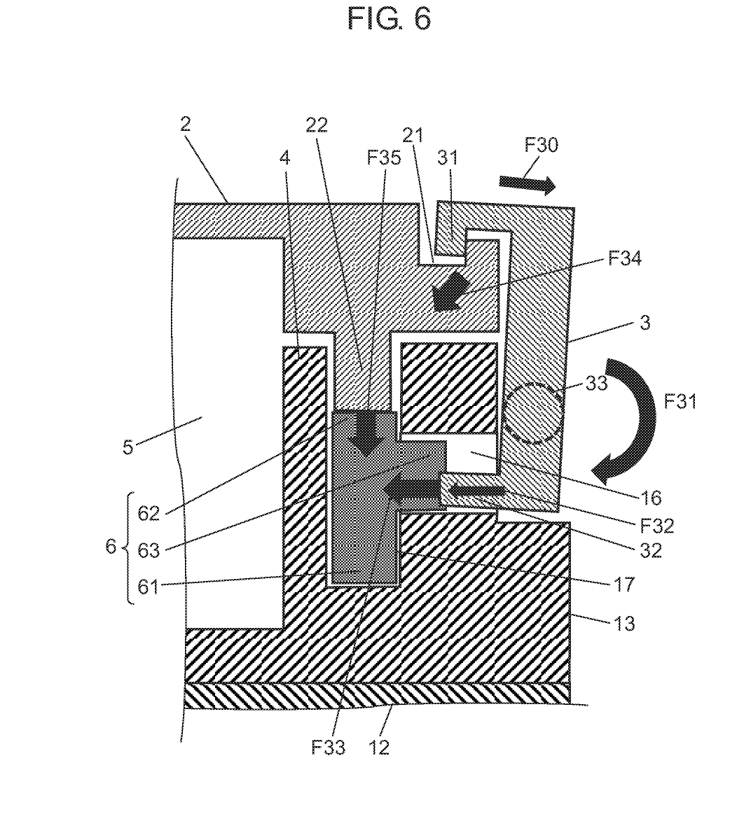

FIG. 6 illustrates a state of the moment at which lock section 3 has rotated slightly in the direction of lock release from the lock position at an impact caused by a fall or the like.

Upon an impact, lock section 3 has a slight rotation in the direction of lock release (as shown by arrow F30), by which first protrusion 31 of lock section 3 pushes lid 2 down (in the direction of arrow F34). The movement allows first abutment section 22 of lid 2 to compress buffer member 6 downward (in the direction of arrow F35). At the same time, the rotation of rotation shaft 33 of lock section 3 (shown by arrow F31) allows second protrusion 32 of lock section 3 to compress buffer member 6 leftward (in the direction of arrow F32 and arrow F33).

After having compression above, as shown in FIG. 5, resilient buffer member 6 pushes back abutment section 22 of lid 2 by its reaction force (as shown by arrow F10), i.e., lid 2 is pushed upward. As a result, first protrusion 31 of lock section 3 engages in second groove 21 of lid 2, suppressing the movement of lock section 3 toward the direction of lock release. Besides, the reaction force (shown by arrow F20) of resilient buffer member 6 pushes back second protrusion 32 of lock section 3. Having the pushing force, lock section 3 rotates, with the rotation of rotation shaft 33 (shown by arrow F21), in the direction of lock position (shown by arrow F22).

[2-3. Lock-Released State]

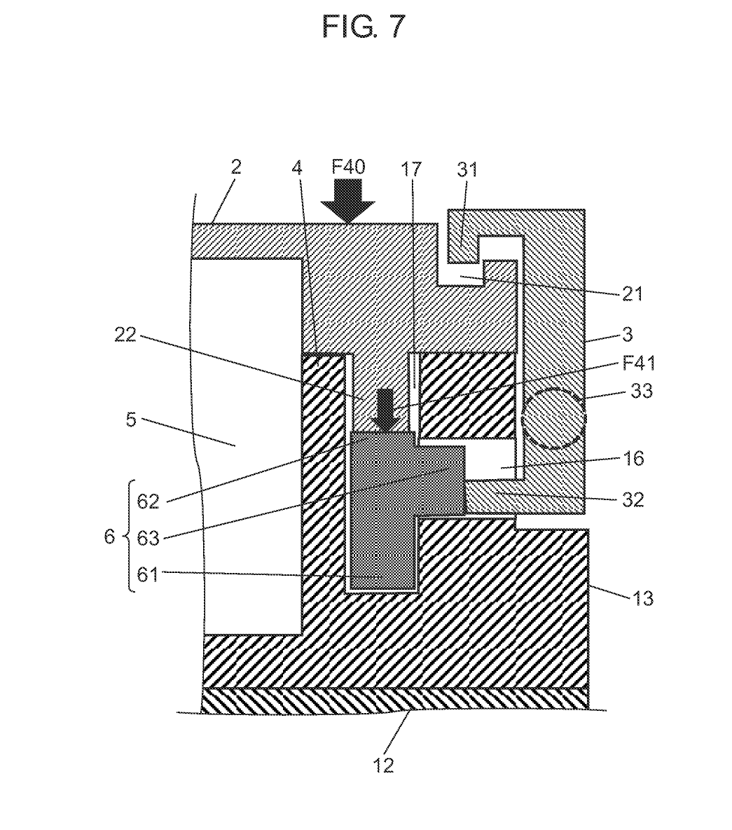

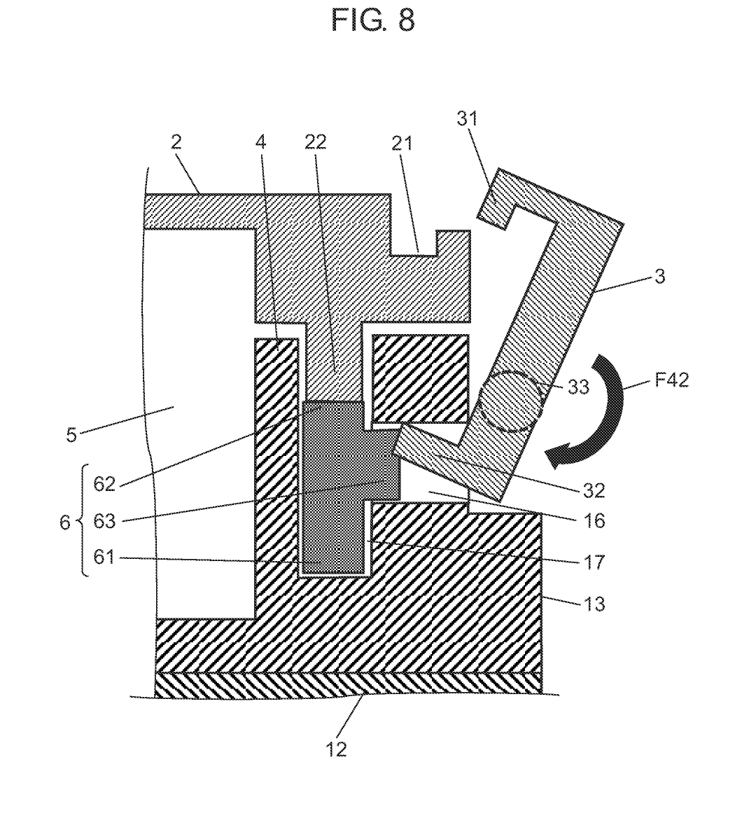

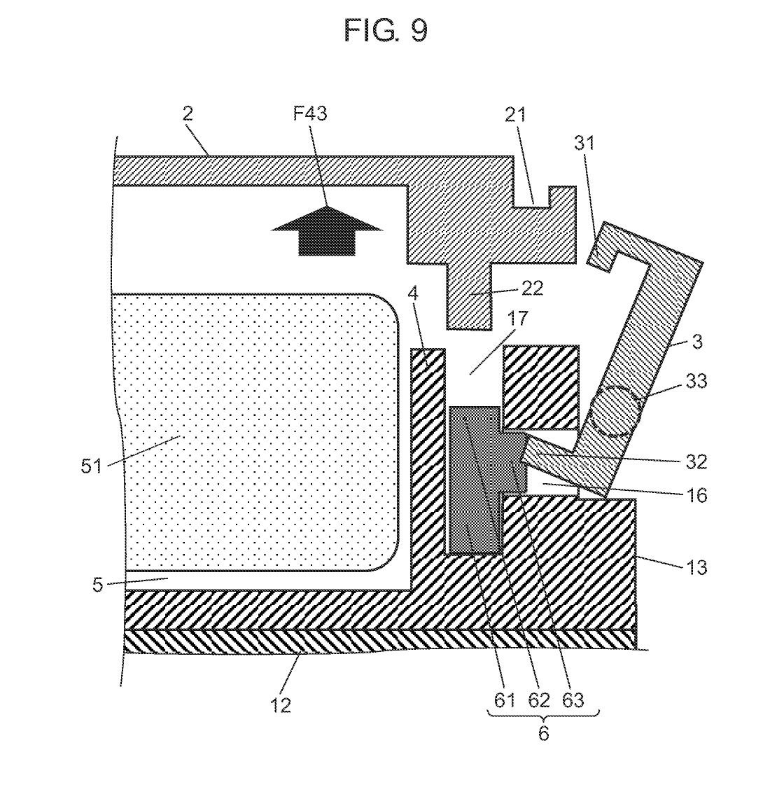

FIG. 7 illustrates a lock-release operation of the lock mechanism. FIG. 8 illustrates the lock-released state of the lock mechanism. FIG. 9 illustrates a state, where the lid has been removed, of the lock mechanism.

As shown in FIG. 7, when lid 2 is pushed down (in the direction of arrow F40), buffer member 6 has a compressive deformation by pushing force (shown by arrow F41) of abutment section 22. Through the movement, the engagement of first protrusion 31 with second groove 21 is released. After that, as shown in FIG. 8, lock section 3 can be manually rotated (in the direction of arrow F42) to the position where the lock state is completely released. Buffer member 6, since it is elastically deformable, changes its shape easily at a deformation rate by manual operation, and therefore the user can easily rotate lock section 3 to the lock release position. In this way, as shown in FIG. 9, the user can remove lid 2 (as shown by arrow F43) to take out battery 51 from storage section 5.

Conversely, lock section 3 can be put back in place by the following procedure:
set battery 51 in storage section 5;
cover storage section 5 with lid 2; and
engage first protrusion 31 of lock section 3 in second groove 21, while pushing lid 2 toward back cover 13.

### [3. Effect]

As described above, electronic device 1 of the exemplary embodiment has the lock mechanism capable of engaging back cover 13 having storage section 5 with lid 2 for covering storage section 5. Lid 2 is removable from back cover 13 or is disposed on it so as to be openable/closable.

Back cover 13 has first groove 17 and opening 16 on the outer side of storage section 5. Lock section 3 has first protrusion 31 on one end and second protrusion 32 on the other end. First protrusion 31 engages with lid 2 and second protrusion 32 is inserted in opening 16. Lock section 3 rotates on rotation shaft 33 located between first protrusion 31 and second protrusion 32. Buffer member 6 is disposed in first groove 17. When buffer member 6 abuts back cover 13, lid 2, and second protrusion 32 of lock section 3, it elastically changes its shape. Lid 2 has second groove 21 and abutment section 22 extending toward buffer member 6. Second groove 21 engages with lock section 3, and abutment section 22 abuts against buffer member 6. Lock section 3 has a structure in which first protrusion 31 extends toward lid 2 and then protrudes toward back cover 13, while second protrusion 32 protrudes toward storage section 5.

With the structure above, buffer member 6 is pushed by abutment section 22 and second protrusion 32. In response to the pushing force, buffer member 6 produces reaction force—the force pushing back lid 2 in the direction of engagement with the protrusion of lock section 3, and the force rotating lock section 3 toward the direction of engagement with lid 2—so that the locked state is maintained. The structure protects lid 2 from coming off from back cover 13 as the housing.

Buffer member 6 abuts abutment section 22 in first groove 17 on the side of lid 2. The structure allows buffer member 6 to have a length in the direction of first groove 17. That is, buffer member 6 produces sufficient reaction force against the pushing force of abutment section 22. At the same time, the structure allows lid 2 to have a deformation amount enough for releasing the engagement between second groove 21 and first protrusion 31 caused by deformed buffer member 6 in response to the pushing force applied to lid 2 by the user.

Besides, buffer member 6 abuts against second protrusion 32 in opening 16. The positional relation allows buffer member 6 to obtain an appropriate length in the direction of opening 16, by which buffer member 6 produces sufficient reaction force against the pushing force from second protrusion 32. When an external force acts on the lock mechanism in the direction in which the engagement of first protrusion 31 with second groove 21 is released, buffer member 6 has a compressive deformation due to the pushing force by abutment section 22 and second protrusion 32. At that time, compressively deformed buffer member 6 generates reaction force, allowing the lock mechanism to go back into the locked state.

With the structure above, even if lock section 3 rotates in the direction of lock release when the device has an impact, for example, by falling, the structure allows the lock mechanism to have a force that takes lock section 3 back to the original lock position. The locked state is thus maintained. Besides, the structure employs a rate-dependent buffer member as buffer member 6. By virtue of the characteristics, even if lock section 3 has increased rotation speed with increase in impact of falling, buffer member 6 is insusceptible to deformation, which suppresses the rotation of lock section 3 in the direction of lock release.

On the other hand, the locked state of the lock mechanism can be easily released as necessary; when lid 2 is pushed, buffer member 6 has a compressive deformation, allowing the engagement of first protrusion 31 with second groove 21 to be released.

As described above, the buffer member easily changes its shape in response to pushing operation by the user, so that lock section 3 can be easily rotated in the direction of lock release. Besides, the structure employs a rate-dependent buffer member as buffer member 6. By virtue of the characteristics, buffer member 6 is insusceptible to deformation at an increased deformation rate caused by an impact of falling, suppressing the rotation of lock section 3 in the direction of lock release.

### Other Exemplary Embodiments

The structure described in the first exemplary embodiment is merely an example of the technique of the present disclosure. That is, the technique of the present disclosure is not limited to the structure described above but is applicable to exemplary embodiments with various changes and modifications. Further, a combination of the components described in the first exemplary embodiment may form another structure other than the example described above. Hereinafter, other exemplary embodiments will be described.

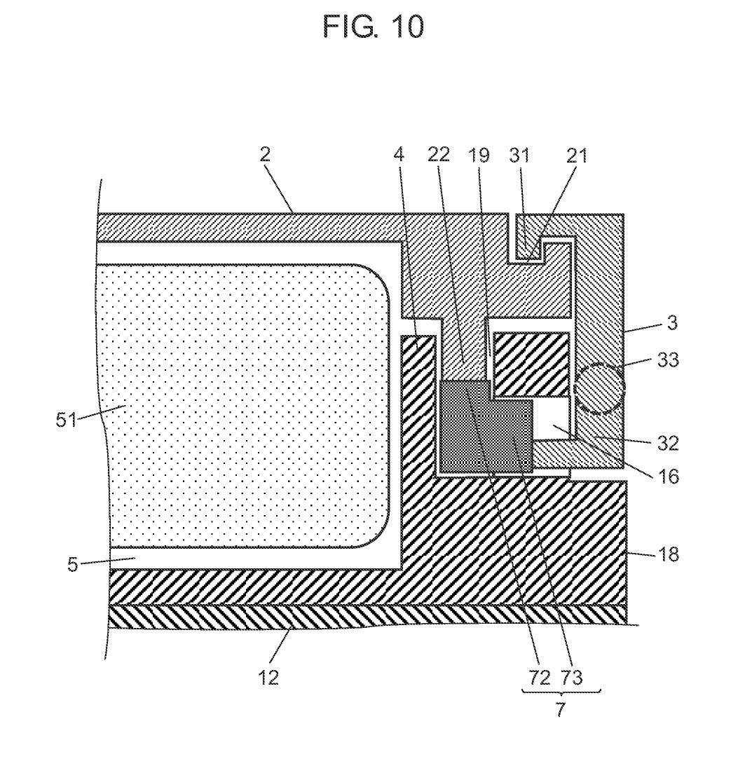

The shape of buffer member 6 is not limited to that described in the first exemplary embodiment. FIG. 10 shows modification A of the buffer member. As shown in FIG. 10, the shape of buffer member 7 has no limitation as long as it contacts with abutment section 22 of lid 2 and second protrusion 32 of lock section 3. For example, buffer member 7 of FIG. 10 has an L-shape cross section and contains second insert section 72 and third insert section 73. Like buffer member 6 described in the first exemplary embodiment, second insert section 72 is inserted in first groove 19 on the side of lid 2 and abuts abutment section 22 of lid 2 in first groove 19. Third insert section 73 is inserted in opening 16 and abuts second protrusion 32 of lock section 3 in opening 16. Buffer member 7, too, contacts with abutment section 22 of lid 2 and second protrusion 32 of lock section 3 and works in the same manner as the lock mechanism of FIGS. 5 through 9 in the first exemplary embodiment.

As shown in FIG. 10, buffer member 7 does not have a first insert section (corresponding to first insert section 61). In addition, first groove 19 of back cover 18 is formed on the lid-2 side only, not on the side of front cover 12. Compared to buffer member 6 of the first exemplary embodiment, buffer member 7 may have a constraint on obtaining a sufficient length in the direction of the first groove. However, as long as having reaction force enough for the lock mechanism and having a deformation amount of lid 2 enough for the lock release, the shape of buffer member 7 can be employed.

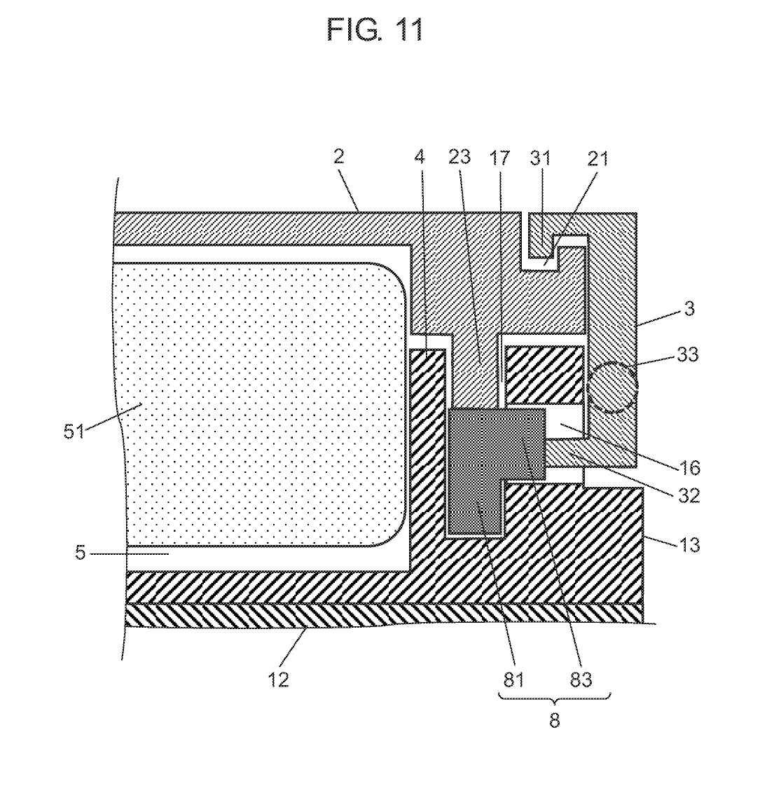

Next, another modification example (modification B) of the buffer member will be described below. FIG. 11 shows modification B of the buffer member. Buffer member 8 of FIG. 11 has an L-shape cross section and contains first insert section 81 and third insert section 83. Like buffer member 6 described in the first exemplary embodiment, first insert section 81 is inserted in first groove 17 on the side of front cover 12 and abuts back cover 13, while third insert section 83 is inserted in opening 16 and abuts second protrusion 32 of lock section 3 in opening 16. Buffer member 8, too, contacts with abutment section 23 of lid 2 and second protrusion 32 of lock section 3 and works in the same manner as the lock mechanism of FIGS. 5 through 9 in the first exemplary embodiment.

As shown in FIG. 11, buffer member 8 does not have a third insert section (corresponding to third insert section 63); it has no portion inserted in first groove 17 on the side of lid 2. To contact with buffer member 8, abutment section 23 of lid 2 is formed longer, in the direction of the first groove, than protrusion 22 of the first exemplary embodiment. Compared to buffer member 6 of the first exemplary embodiment, buffer member 8 may have a constraint on obtaining a sufficient length in the direction of the first groove. However, as long as having reaction force enough for the lock mechanism (described in FIGS. 5 through 9) and having a deformation amount of lid 2 enough for the lock release, the shape of buffer member 8 can be employed.

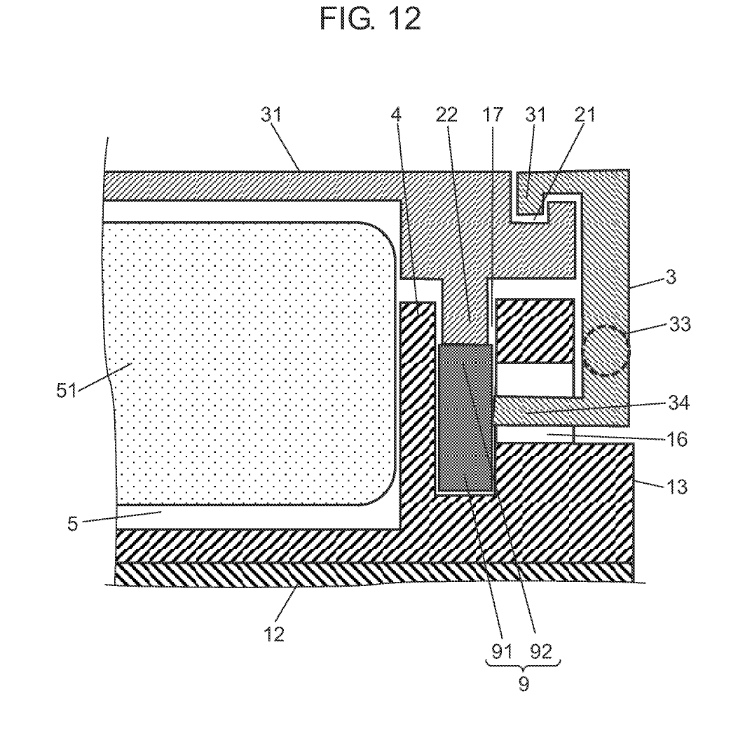

Next, still another modification example (modification C) of the buffer member will be described below. FIG. 12 shows modification C of the buffer member. Buffer member 9 of FIG. 12 has an I-shape cross section and contains first insert section 91 and second insert section 92. Like buffer member 6 described in the first exemplary embodiment, first insert section 91 is inserted in first groove 17 on the side of front cover 12 and abuts back cover 13, while second insert section 92 is inserted in first groove 17 on the side of lid 2 and abuts second protrusion 22 of lid 2. Buffer member 9, too, contacts with abutment section 22 of lid 2 and second protrusion 34 of lock section 3 and works in the same manner as the lock mechanism of FIGS. 5 through 9 in the first exemplary embodiment.

As shown in FIG. 12, buffer member 9 does not have a third insert section (corresponding to third insert section 63); it has no portion inserted in opening 16. To contact with buffer member 9, second protrusion 34 of lock section 3 is formed longer, in the direction of opening 16, than second protrusion 32 of the first exemplary embodiment. Compared to buffer member 6 of the first exemplary embodiment, buffer member 9 may have a constraint on obtaining a sufficient length in the direction of opening 16. However, as long as having reaction force enough for the lock mechanism (described in FIGS. 5 through 9), the shape of buffer member 9 can be employed.

Compared to buffer member 6, each of buffer members 7, 8, and 9 has a simple shape and therefore they can be easily produced and fixed to the back cover.

Besides, the buffer member may serve as a waterproof member. In that case, as shown in FIG. 4 of the first exemplary embodiment, when buffer member 6 has a shape that fills opening 16 and first groove 17 on the both sides of front cover 12 and lid 2, the waterproof effect enhances.

According to the structure of the first exemplary embodiment, rotation shaft 33 is disposed on lock section 3. However, lock section 3 does not necessarily have rotation shaft 33, as long as lock section 3 can rotate on back cover 13, i.e., as long as lock section 3 can rotate on the rotation shaft located between first protrusion 31 on one end of lock section 3 and second protrusion 32 on the other one of lock section. For example, to structure the lock mechanism of lock section 3, the rotation shaft may be disposed on back cover 13, and a recess to be fitted with the rotation shaft may be disposed on lock section 3. Further, the rotation shaft may be formed as an independent member. In that case, a recess to be fitted with the rotation shaft is disposed on each of back cover 13 and lock section 3. The rotation mechanism of lock section 3 is obtained by engaging the rotation shaft with the recesses.

### INDUSTRIAL APPLICABILITY

The present disclosure is applicable to a device case having a lid structure; specifically, it is applicable to POS terminals, mobile phones, and portable devices such as a remote-control unit.

What is claimed is:

1. A lock mechanism comprising:
a housing having a storage section, a first groove and an opening formed on an outer side of the storage section;
a lid that is disposed on the housing so as to be removable or so as to be openable/closable, the lid covering the storage section;
a lock section comprising:
a first protrusion that is disposed on one end of the lock section and engages with the lid; and
a second protrusion that is disposed on the other end of lock section and is inserted in the opening, wherein the lock section rotates on a rotation shaft located between the first protrusion and the second protrusion; and
a buffer member elastically deformable, disposed in the first groove, and abutting the housing, the lid, and the second protrusion of the lock section.

2. The lock mechanism according to claim 1, wherein the lid has a second groove that engages with the lock section and an abutment section that extends in a direction of the buffer member and abuts the buffer member, the first protrusion of the lock section extends in a direction of the lid and then protrudes in a direction of the housing, while the second protrusion protrudes in a direction of the storage section.

3. The lock mechanism according to claim 2, wherein the buffer member abuts against the abutment section in the first groove on a side of the lid.

4. The lock mechanism according to claim 1, wherein the buffer member abuts against the second protrusion in the opening.

5. The lock mechanism according to claim 1, wherein the buffer member compressively deforms in response to pushing force exerted by the abutment section and the second protrusion, the compressively deformed buffer member produces reaction force, allowing the lid and the housing to get into a locked state.

6. The lock mechanism according to claim 5, wherein when an external force acts on the lock mechanism in a direction in which engagement of the lid with the first protrusion is released, the buffer member compressively deforms due to the pushing force from the abutment section and the second protrusion, and the compressively deformed buffer member produces the reaction force, allowing the second groove and the first protrusion to go back into the locked state.

7. The lock mechanism according to claim 1, wherein the buffer member compressively deforms due to pushing force applied to the lid, allowing the engagement of the lid with the first protrusion to be released.

8. The lock mechanism according to claim 1, wherein an object to be contained in the storage section is a battery.
